(19) United States
(12) Patent Application Publication
(10) Pub. No.: US 2010/0026687 A1
(43) Pub. Date: Feb. 4, 2010

(54) SYSTEMS AND METHODS FOR DYNAMICALLY GENERATING LOCATIONS FOR CHARTING ASSESSMENTS

(75) Inventors: Pradeep Shankar, Palatine, IL (US); Richard Kramer, Orem, UT (US); Jyothi Jayaraman, Hoffman Estates, IL (US); Jianyong Zhang, Barrington, IL (US)

Correspondence Address: MCANDREWS HELD & MALLOY, LTD, 500 WEST MADISON STREET, SUITE 3400, CHICAGO, IL, 60661, US

(73) Assignee: General Electric Company, Schenectady, NY (US)

(21) Appl. No.: 12/181,814

(22) Filed: Jul. 29, 2008

(51) Int. Cl. G06T 11/20

(52) U.S. Cl. 345/441

(57) ABSTRACT

Embodiments of the present technology provide a system and method for dynamically generating locations for charting assessments. The system includes a user-operated location authoring tool, an authoring dictionary service, a runtime dictionary service, a database, and a location selector. The method includes creating at least one user-manipulated image; associating at least one location with each of the user-manipulated images; associating each of the user-manipulated image(s) and associated location(s) with at least one knowledge identifier; storing the user-manipulated image(s), associated location(s) and associated knowledge identifier(s); and retrieving the user-manipulated image(s) and associated location(s) relating to a user-selected one of the knowledge identifiers. The present technology also includes a computer-readable medium having a set of instructions for execution by a computer, the set of instruction capable of carrying out the current method.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Generally, the technical field involves systems and methods for dynamically generating locations for charting assessments. In one specific embodiment, the technical field involves dynamically generating body locations for charting patient assessments.

Many fields involve assessment of a problem or situation prior to action based on that problem or situation. For example, a builder might assess a plot of land before laying the structure for a building. Similarly, a photographer might assess the light in a room prior to taking photographs. These assessments are sometimes documented in order to keep accurate records for later use or alert others of the problem or situation. In today's digital society, these assessments are often documented digitally.

In a clinical setting, caregivers commonly document patient assessments. These patient assessments could deal with a number of different types of assessments, for example neurological assessments, skin assessments, and/or orthopedic assessments. Since today's healthcare world is largely digital, these assessments are often stored in enterprise clinical documentation systems.

An important piece of data that is often recorded involves location. A builder may record where a certain type of rock or soil is located on a plot of land. A photographer may want to record were the best light is for his photographs.

In a clinical setting, a particularly important piece of clinical data that is often recorded involves body location. When making an assessment the caregiver often wants to document the location of that assessment. For example, the caregiver may want to document the body locations of bruises and lacerations that exist on an accident victim.

Location can be recorded by presenting the user with an image that represents the place or item on which the location exists. The user is then allowed to pick the portion of that image he or she wishes to record. Body location has typically been recorded in this manner. The caregiver by is presented with an image that represents a body, a part of the body and/or a body system. The caregiver is then allowed to pick the portion of that image he or she wishes to record.

Previous systems used static images mapped to static locations. These limit the body locations a caregiver can record to those that are pre-set in the system. Sometimes a caregiver wants to add a body image that is not available in the pre-set system or modify an existing image to show an element that is not shown in the pre-set system.

If body location information in the images is added and/or updated, this involves engineers and software developers. The engineers and software developers map the new images and update software to read the updated locations. When new body locations are accessed from the body diagrams, clinical users would typically submit a request for the feature. They would then be forced to wait for weeks while the new images and software were developed and deployed to their location. This requires time and efforts spent on software upgrades, verification, validation and testing.

### BRIEF SUMMARY OF THE INVENTION

Certain embodiments of the present technology provide systems and methods for dynamically generating locations for charting assessments. One particular embodiment of the present technology provides systems and methods for dynamically generating body locations for charting patient assessments.

Certain embodiments of the present system for dynamically generating locations for charting assessments include a user-operated location authoring tool wherein the user-operated location authoring tool allows a user to manipulate at least one image; an authoring dictionary service wherein the authoring dictionary service associates at least one location with each of the manipulated images; a runtime dictionary service wherein the runtime dictionary service associates at least one knowledge identifier with the manipulated image(s) and associated location(s); a database wherein the database stores the manipulated image(s), associated location(s) and associated knowledge identifier(s); and a location selector wherein the location selector retrieves the manipulated image(s) and associated location(s) relating to a user-selected one of the knowledge identifiers.

Certain embodiments of the present method for dynamically generating locations for charting assessments include creating at least one user-manipulated image; associating at least one location with each of the user-manipulated images; associating each of the user-manipulated image(s) and associated location(s) with at least one knowledge identifier; storing the user-manipulated image(s), associated location(s) and associated knowledge identifier(s); and retrieving the user-manipulated image(s) and associated location(s) relating to a user-selected one of the knowledge identifiers.

Certain embodiments of the present computer-readable medium having a set of instructions for execution by a computer include a user-manipulation routine configured to allow a user to manipulate at least one image; a first association routine configured to associate at least one location with each of the user-manipulated images; a second association routine configured to associate each of the user-manipulated image(s) and associated location(s) with at least one knowledge identifier; a storage routine configured to store the user-manipulated image(s), associated location(s) and associated knowledge identifier(s); and a selection routine configured to retrieve the user-manipulated image(s) and associated location(s) relating to a user-selected one of the knowledge identifiers.

These and other features of the present invention are discussed or apparent in the following detailed description.

### BRIEF DESCRIPTION OF SEVERAL VIEWS OF THE DRAWINGS

FIG. 1 illustrates a system for dynamically generating locations for charting assessments according to an embodiment of the present technology.

FIG. 2 illustrates a flow diagram for a method of dynamically generating locations for charting assessments according to an embodiment of the present technology.

FIG. 3 illustrates an exemplary screen shot of a system for dynamically generating body locations for charting patient assessments according to an embodiment of the present technology.

FIG. 4 illustrates an exemplary screen shot of a system for dynamically generating body locations for charting patient assessments according to an embodiment of the present technology.

FIG. 5 illustrates an exemplary screen shot of a system for dynamically generating body locations for charting patient assessments according to an embodiment of the present technology.

FIG. 6 illustrates an exemplary screen shot of the authoring application of a system for dynamically generating body locations for charting patient assessments according to an embodiment of the present technology.

FIG. 7 illustrates an exemplary screen shot of the authoring application of a system for dynamically generating body locations for charting patient assessments according to an embodiment of the present technology.

FIG. 8 illustrates an exemplary screen shot of the authoring application of a system for dynamically generating body locations for charting patient assessments according to an embodiment of the present technology.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

The current technology relates to systems and methods for dynamically generating locations for charting assessments. Although clinical systems and methods are used as examples, the current technology should not be viewed as limited to such systems.

In many fields, an individual makes assessments about certain locations and chart those assessments. For example, a builder may want to make assessments about certain locations on a building site. Similarly, a park official may want to make assessments of certain locations of the park. As discussed above, these assessments can be charted using digital means that can involve selecting the desired image and location from a pre-set group of images. However, a pre-set group of static images do not always meet the user's needs. In order to avoid the use of software engineers to individually modify software to read updated images each time the user wants a new image, the current technology dynamically reads in new diagrams and locations from a knowledge asset database defined by the users themselves.

In one exemplary embodiment, the current technology uses a software tool known as dynamic location selector to dynamically read images and associated image maps from a database when invoked by a calling application. They dynamic location selector will also read other detailed images linked to the main image. The calling application can be an assessment form. The assessment form would have knowledge about image identifiers used during a given assessment. The calling application would invoke the dynamic location selector asking it to load a set of images and image maps based on knowledge identifiers. The images and image maps will be defined by users and saved in a database. The users can independently manipulate the images and image maps to add more locations, update locations or increase image resolution and/or size. This current technology provides a flexible solution to the problem of generating images and locations for various settings.

Clinically there is a desire to be able to add/modify images and body location information dynamically by clinicians. There is also a desire to be able to link a high level body image to other detailed images. In order to avoid the use of software engineers to individually modify software to read updated body image locations, the current technology dynamically reads in new body diagrams and locations from a knowledge asset database defined by the clinical users themselves.

In a clinical setting, the current technology allows clinicians to add new body locations, modify existing body diagrams, and/or attach detailed body diagrams to a main body diagram without engineering involvement. The current technology would also allow clinicians to automatically see modified body diagrams and new locations on clinical forms without engineering involvement. The current technology would also allow healthcare institutions to customize body locations for different clinical settings. For example, the body locations could be changed for use in an oncology setting versus a pediatric setting. Productivity can be vastly increased by allowing clinical users to define the clinical content without engineering involvement and software updates.

In a clinical setting, one exemplary embodiment of the current technology uses a software tool known as dynamic body location selector to dynamically read body images and associated image maps from a database when invoked by a calling application. They dynamic body location selector will also read other detailed images linked to the main image. The calling application can be a patient assessment form, such as a skin assessment form. The assessment form would have knowledge about image identifiers used during a given assessment, for example those used during a skin assessment. The calling application would invoke the dynamic body location selector asking it to load a set of body images and image maps based on knowledge identifiers. The images and image maps will be defined by expert clinical users and saved in a database. The expert clinical users can independently manipulate the body images and image maps to add more locations, update locations or increase image resolution and/or size. The current technology provides a flexible solution to the problem of generating body images and locations for various clinical settings.

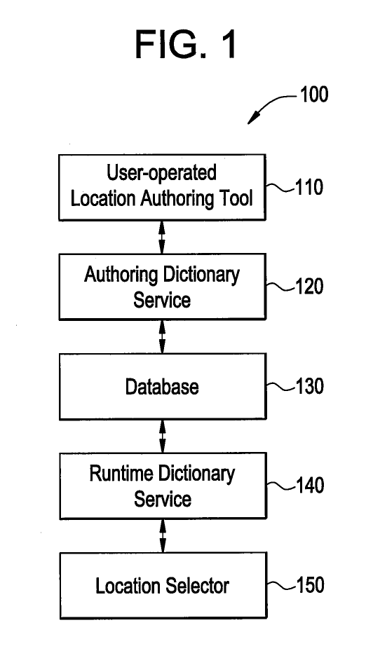

FIG. 1 illustrates a system (100) for dynamically generating locations for charting assessments according to an embodiment of the present technology. In one embodiment, the present system (100) comprises a user-operated location authoring tool (110), an authoring dictionary service (120), a runtime dictionary service (140), a database (130), and a location selector (150).

The user-operated location authoring tool (110) is in communication with the authoring dictionary service (120) and vice versa. The authoring dictionary service (120) is in communication with the database (130) and vice versa. The database (130) is in communication with the runtime dictionary service (140) and vice versa. The runtime dictionary service (140) is in communication with the location selector (150) and vice versa.

The components of the system (100) may be implemented alone or in combination with hardware, firmware, and/or as a set of instructions in software, for example. Certain embodiments may be provided as a set of instructions residing on a computer-readable medium, such as a memory, hard disk, DVD, or CD, for execution on a general purpose computer or other processing device. The system may be integrated in various forms and/or may be provided as software and/or other functionality on a computing device, such as a computer. Certain embodiments may omit one or more of the components of the system (100).

The current system (100) is comprised of a user-operated location authoring tool (110). The user-operated location authoring tool (110) allows a user to manipulate at least one image. The user-operated location authoring tool (110) allows the user to carry out various manipulations on new and/or pre-set images. As non-limiting examples, the user-operated location authoring tool (110) could allow a user to create new images, modify pre-set images and/or link high level body images with more specific detailed images. A single embodiment could allow the user to do a combination of these and similar tasks.

In one embodiment, the user-operated location authoring tool (110) would allow a user to create new images. The user-operated location authoring tool (110) would have various applications to assist the user in creating new images. For example, the user-operated location authoring tool (110) could have a drawing application that allows the user to draw the desired image, pre-set shapes that the user can use in creating the new image, and/or commonly used image elements that the user can use in creating the new images. A user who wants an image of a system that does not exist in the pre-set images could enter the user-operated location authoring tool (110) and use the various applications in the user-operated location authoring tool (110) to create the new image he or she wants. This allows the user to obtain new diagrams without engineering involvement.

Another embodiment, would allow the user to modify pre-set images already in the database. For example, the user could add an element to a pre-set image, delete and element from a pre-set image, change the orientation of a pre-set image, zoom in on one area of a pre-set image, zoom out to show a larger portion of a pre-set image, add new locations, update locations, increase image resolution, decrease image resolution, increase image size and/or decrease image size. The user-operated location authoring tool (110) would have various applications allowing a user to modify existing pre-set images in these manners. This allows the user to modify pre-set images without engineering involvement.

Yet another embodiment would allow the user to link high level images with more detailed, specific images. This would allow the user to link a detailed image with a larger, less detailed image. For example, a clinician might link a specific, detailed image of a knee with a high level image of a leg. The user-operated location authoring tool (110) will have applications to assist the user in linking the images. This element of the user-operated location authoring tool (110) allows the user to link images without engineering involvement.

The user-operated location authoring tool (110) is in communication with an authoring dictionary service (120). The authoring dictionary service (120) associates at least one location with each of the images that were manipulated using the user-operated authoring tool (110). Locations can be associated with pre-set images, new images and/or modified images. New locations, previously used locations or modified locations can be associated with the images.

The authoring dictionary service (120) could associate locations that the user added or updated using the user-operated location authoring tool (110) with an image. As an example, the user could want to add new locations onto one of the pre-set images. The user could input the new locations using the user-operated location authoring tool (110). The authoring dictionary service (120) would then associate the newly added locations with the pre-set image. Similarly, the user could want to update locations on one of the pre-set images. The user could update the locations using the user-operated location authoring tool (110). The authoring dictionary service (120) would then associate the updated locations with the pre-set image.

The authoring dictionary service (120) would also associate locations with a new image created using the user-operated location authoring tool (110). After a user creates a new image, locations would be added to the new image. After the new locations are added, the authoring dictionary service associates (120) the new locations with the new image. In one embodiment, the original user could input the new locations using the user-operated location authoring tool (110). In another embodiment, another user could input the new locations using a related user-operated location authoring tool (110). In yet another embodiment, applications associated with the authoring dictionary service (120) would determine the new locations and associate the new locations with the new image.

The authoring dictionary service (120) would also associate locations with modified images that were modified using the user-operated location authoring tool (110). After a user modifies an image, certain locations might be modified. After the locations are modified, the authoring dictionary service (120) associates the modified locations with the modified image. In one embodiment, the original user could input the modified locations using the user-operated location authoring tool (110). In another embodiment, another user could input the modified locations using a related user-operated location authoring tool (110). In yet another embodiment, applications associated with the authoring dictionary service (120) would determine the modified locations and associate the modified locations with the modified image. Locations that do not relate to a modified element of the image would remain the same and the authoring dictionary service (120) would continue to associate those locations as before.

The authoring dictionary service (120) is in communication with a database (130). The database stores the manipulated image(s) and associated location(s). The database (130) would store pre-set images, new images and/or modified images. The database (130) would also store new locations, previously used locations or modified locations. The database (130) would also store the association between the images and locations. The database (130) would be dynamically updated whenever an image is manipulated, a location changed or an association changed.

The current system is comprised of a runtime dictionary service (140). The runtime dictionary service (140) associates at least one knowledge identifier with the manipulated image(s) and associated location(s). The knowledge identifier categorizes the image in order to aide in image retrieval by a user. For example, body images relating to the chest would be associated with a knowledge identifier indicating their relation to the chest. An image could have multiple knowledge identifiers. For example, a body image of the lung could be identified as lung, respiratory and/or chest.

When the images are manipulated using the user-operated location authoring tool (110) or when the associations are changed by the dictionary authoring service (120), the runtime dictionary service (140) will associate the appropriate knowledge identifier with the manipulated image and associated locations. For example, if a new body image of the chest was created, the runtime dictionary service (140) would associate a chest knowledge identified with the image.

The knowledge identifiers are then stored in the database (130) along with the images, locations and associations between the three. The runtime dictionary service (140) is in communication with the database (130). The database (130) is dynamically updated with knowledge identifiers as new associations are created.

The current system is comprised of a location selector (150). The location selector retrieves the manipulated image(s) and associated location(s) relating to a user-selected one of the knowledge identifiers. The location selector (150) allows a user to retrieve images and associated locations. The user inputs a knowledge identifier into the location selector (150). The location selector (150) retrieves the manipulated images and associated locations that correspond to that knowledge identifier. The user can then select the desired image from the group of images returned by the location selector (150). Once the user has found the desired image he or she can make and chart assessments regarding location using the desired image and associated locations.

The location selector can take the form of a calling application or assessment form. The calling application or assessment form would obtain related images by calling up images having knowledge identifiers associated to a certain assessment. For example, the assessment form could be a skin assessment form. The calling application would return the images related to the skin assessment form.

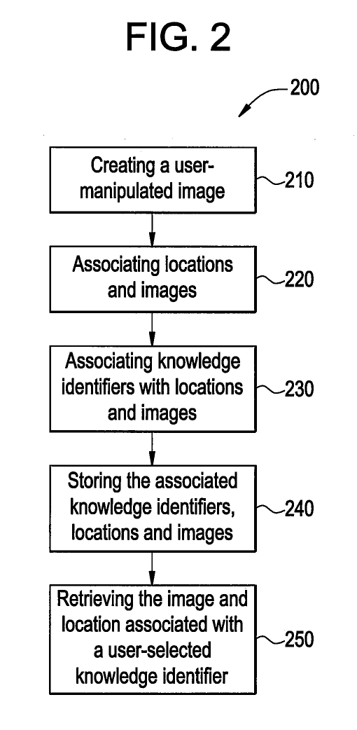

FIG. 2 illustrates a method (200) of dynamically generating locations for charting assessments according to an embodiment of the present technology. The method (200) involves the user-manipulated images (120); associating each of the user-manipulated image(s) and associated location(s) with at least one knowledge identifier (130); storing the user-manipulated image(s), associated location(s) and associated knowledge identifier(s) (140); and retrieving the user-manipulated image(s) and associated location(s) relating to a user-selected one of the knowledge identifiers (150). These steps can be performed sequentially or in another order.

In the first step, at least one user-manipulated image is created (110). This can be done using a user-operated location authoring tool, such as (110) described above. The user can carry out various manipulations on new and/or pre-set images. As non-limiting examples, the user can create new images, modify pre-set images and/or link high level body images with more specific detailed images. The user to do a combination of these and similar tasks during this step.

In one embodiment, the user creates new images. This could be done using a drawing application that allows the user to draw the desired image. The user could also use pre-set shapes in creating the new image. The user could also obtain commonly used image elements from a database and use those in creating the new images. This method allows a user who wants an image that does not exist in a set of pre-set images to create the new image he or she wants.

In another embodiment, the user would modify pre-set images already in the database. For example, the user could add an element to a pre-set image, delete and element from a pre-set image, change the orientation of a pre-set image, zoom in on one area of a pre-set image, zoom out to show a larger portion of a pre-set image, add new locations, update locations, increase image resolution, decrease image resolution, increase image size and/or decrease image size. The user could use various applications to modify existing pre-set images in these manners.

In yet another embodiment, the user could link high level images with more detailed, specific images. The user would link a detailed image with a larger, less detailed image. For example, a clinician might link a specific, detailed image of a heart with a high level image of a circulatory system. The user can use various applications to assist in linking the images.

In the next step, at least one location is associated with each of the user-manipulated images (120). This can be done using an authoring dictionary service, such as (120) described above. Locations can be associated with pre-set images, new images and/or modified images. New locations, previously used locations or modified locations can be associated with the images.

Locations that the user added or updated in the first step could be associated with manipulated or pre-set images. As an example, the user could want to add new locations onto one of the pre-set images. The user could input the new locations in the first step and then associate the newly added locations with the pre-set image. Similarly, the user could want to update locations on one of the pre-set images. The user could update the locations in the first step and then associate the updated locations with the pre-set images.

The user could also associate locations with a new image created in the first step. After a user creates a new image, locations would be added to the new image. After the new locations are added, the new locations are associated with the new image. In one embodiment, the original user could add the new locations. In another embodiment, another user could add the new locations.

The user could also be associated with modified images that were modified in the first step. After a user modifies an image, certain locations might be modified. After the locations are modified, the modified locations are associated with the modified image. In one embodiment, the original user could add the modified locations. In another embodiment, another user could add the modified locations. Locations that do not relate to a modified element of the image would remain the same and would continue to be associated with the image as before.

In the next step, at least one knowledge identifier is associated with each of the user-manipulated image(s) and associated location(s) with (130). This can be done using a runtime dictionary service, such as (140) described above. The knowledge identifier categorizes the image in order to aide in image retrieval by a user. For example, body images relating to the reproductive system would be associated with a knowledge identifier indicating their relation to the reproductive system. An image could have multiple knowledge identifiers. For example, a body image of an ovary could be identified as female, reproductive system and/or ovary.

When the images are manipulated or when the associations are changed appropriate knowledge identifier is associated with the manipulated image and associated locations. For example, if a new body image of a brain was created, the runtime dictionary service (140) would associate a brain knowledge identified with the image.

In the next step the user-manipulated image(s), associated location(s) and associated knowledge identifier(s) are stored (140). This can be done using a database, such as (130) described above. Pre-set images, new images and/or modified images are stored. New locations, previously used locations and/or modified locations are stored. The knowledge identifiers are also stored. The associations between the images, locations and knowledge identifiers are also stored. The storage is dynamically updated with manipulated images, locations and knowledge identifiers as manipulations are carried out and new associations are created.

In the next step, the user-manipulated image(s) and associated location(s) relating to a user-selected knowledge identifier are retrieved (150). This can be done using a location selector, such as (150) described above. The user can select a knowledge identifier. The manipulated images and associated locations that correspond with that knowledge identifier are then retrieved. The user can then select the desired image from the group of images. Once the user has found the desired image he or she can make and chart assessments regarding location using the desired image and associated locations.

The images, locations and associations can be retrieved using a calling application or assessment form. The calling application or assessment form would obtain related images by calling up images having knowledge identifiers associated to a certain assessment. For example, the assessment form could be a skin assessment form. The calling application would return the images related to the skin assessment form.

One or more of the steps of the methods (200) may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

Certain embodiments may be implemented in one or more of the systems described above. For example, certain embodiments of the method (200) may be implemented using one or more local EMR (electronic medical record) systems, a database or other data storage storing electronic data, and one or more user interfaces facilitating capturing, integrating and/or analyzing information inputted by the patient.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

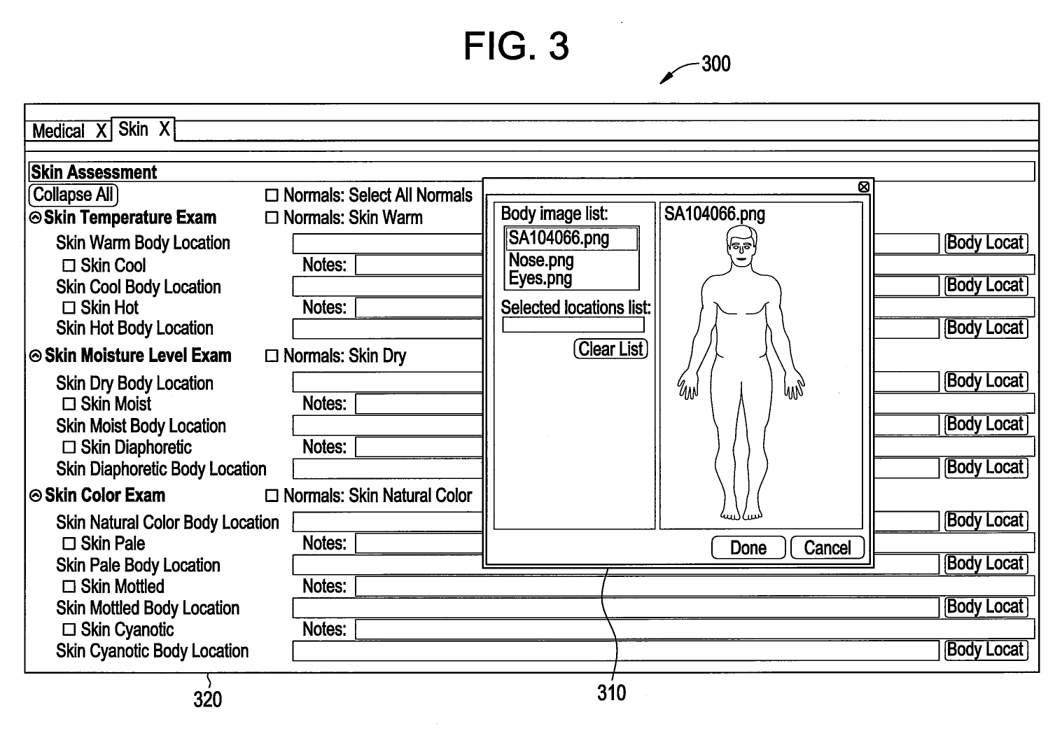

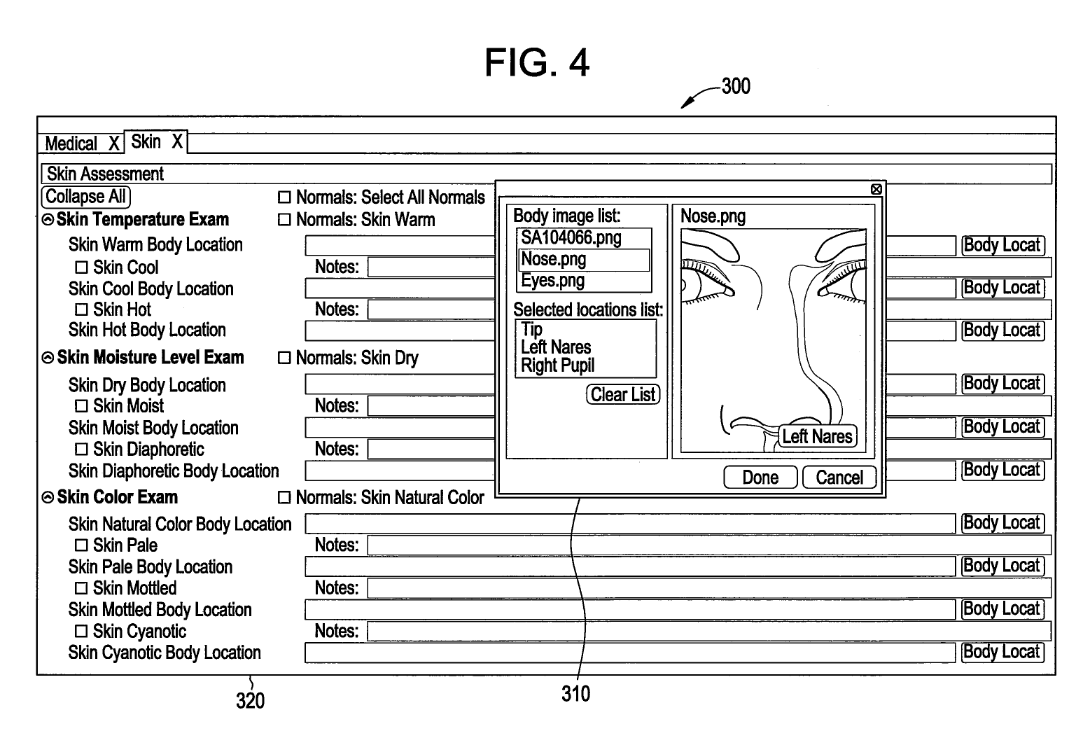

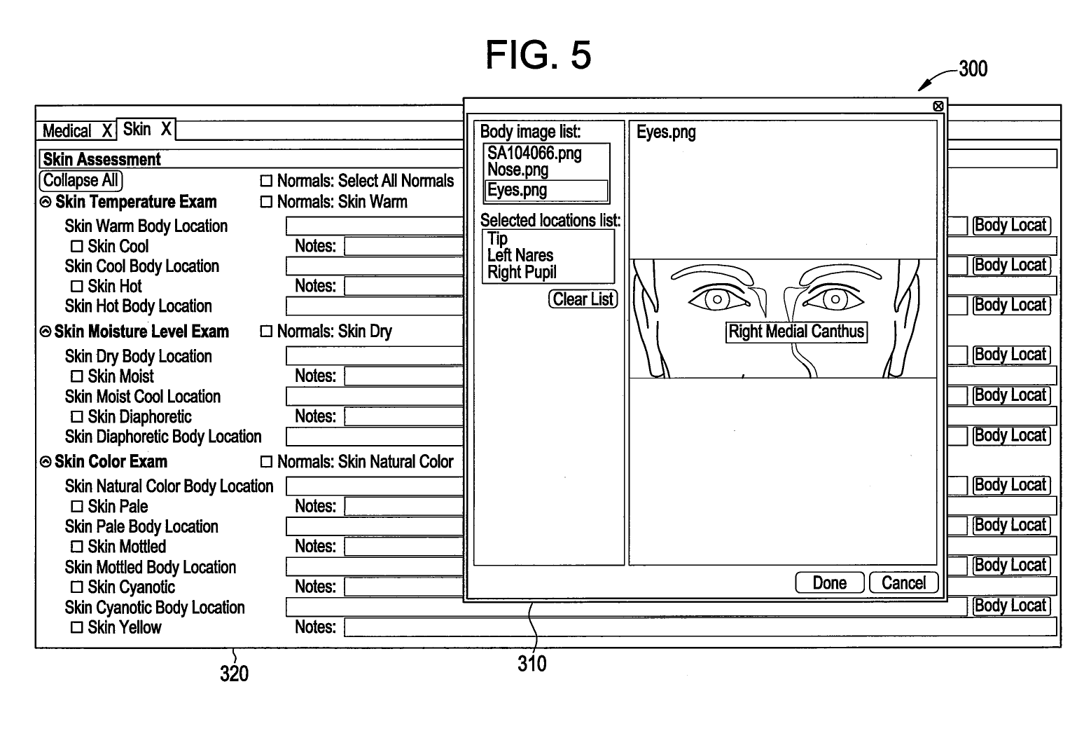

FIGS. 3-5 illustrate exemplary screen shots (300) of systems for dynamically generating body locations for charting patient assessments according to embodiments of the present technology. FIGS. 3-5 display exemplary screen shots (300) of systems for charting skin assessments. The screen shot displays a first window (310) containing a user-manipulated image, possibly created using a user-operated location authoring tool such as (110) above. The screen shot also displays a second window (320) displaying the location selector application along with an application allowing the user to chart assessments and locations. The manipulated image in the first window (310) is associated with locations, possibly using a dictionary authoring service such as (120) above. The manipulated image and associated locations are then associated with knowledge identifiers, possibly using a runtime dictionary service such as (140) above. These manipulated images, locations, knowledge identifiers and associations are stored, possibly in a database such as (130) above. Any new manipulations, locations or associations are stored. If a database such as (130) above is used it would by dynamically updated. The second window (320) allows the user to access the manipulated images and associated locations using knowledge identifiers, this could be done using a location selector such as (150) described above. The user can then use the second window (320) to chart assessments regarding the locations associated with the manipulated images.

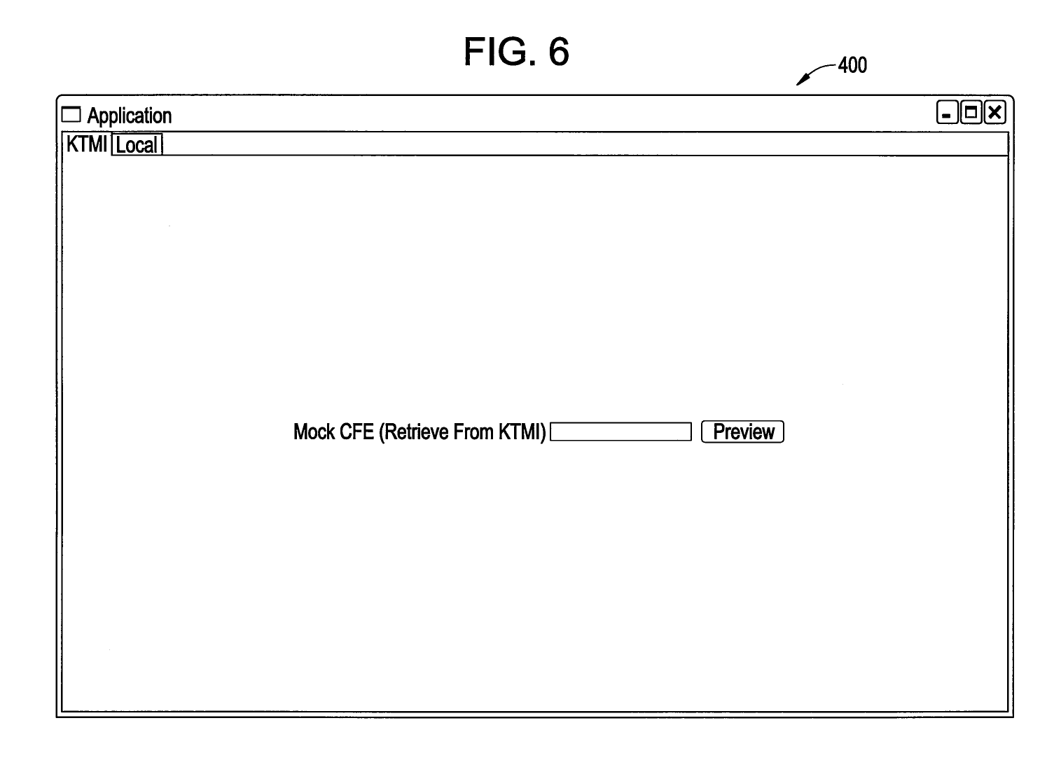

FIG. 6-8 illustrates exemplary screen shots (400) of the authoring application of a system for dynamically generating body locations for charting patient assessments according to an embodiment of the present technology. The screen shots (400) are examples of a user-operated location authoring tool such as (110) discussed above. The screen shots (400) have a screen or multiple screens that allow a user to manipulate at least one image. The screens have applications that allow the user to carry out various manipulations on new and/or pre-set images. For example, applications that allow a user to create new images, modify pre-set images and/or link high level body images with more specific detailed images.

FIG. 6 shows a screen that allows the user to link high level images with more detailed, specific images. This would allow the user to link a detailed image with a larger, less detailed image. For example, a clinician might link a specific, detailed image of a knee with a high level image of a leg. This screen has applications to assist the user in linking the images. This allows the user to link images without engineering involvement.

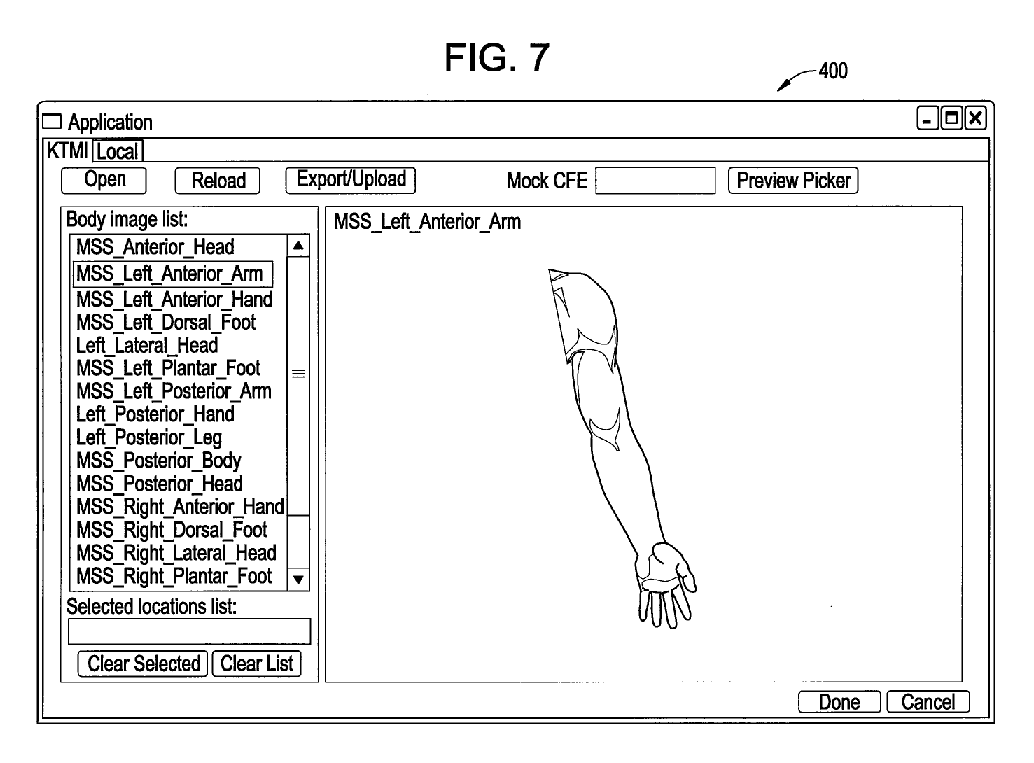

FIG. 7 shows a screen that allows a user to create new images. This screen has various applications to assist the user in creating new images. For example, the screen shows a drawing application that allows the user to draw the desired image, pre-set shapes that the user can use in creating the new image, and/or commonly used image elements that the user can use in creating the new images. A user who wants an image of a system that does not exist in the pre-set images could enter this screen and use the various to create the new image he or she wants. This allows the user to obtain new diagrams without engineering involvement.

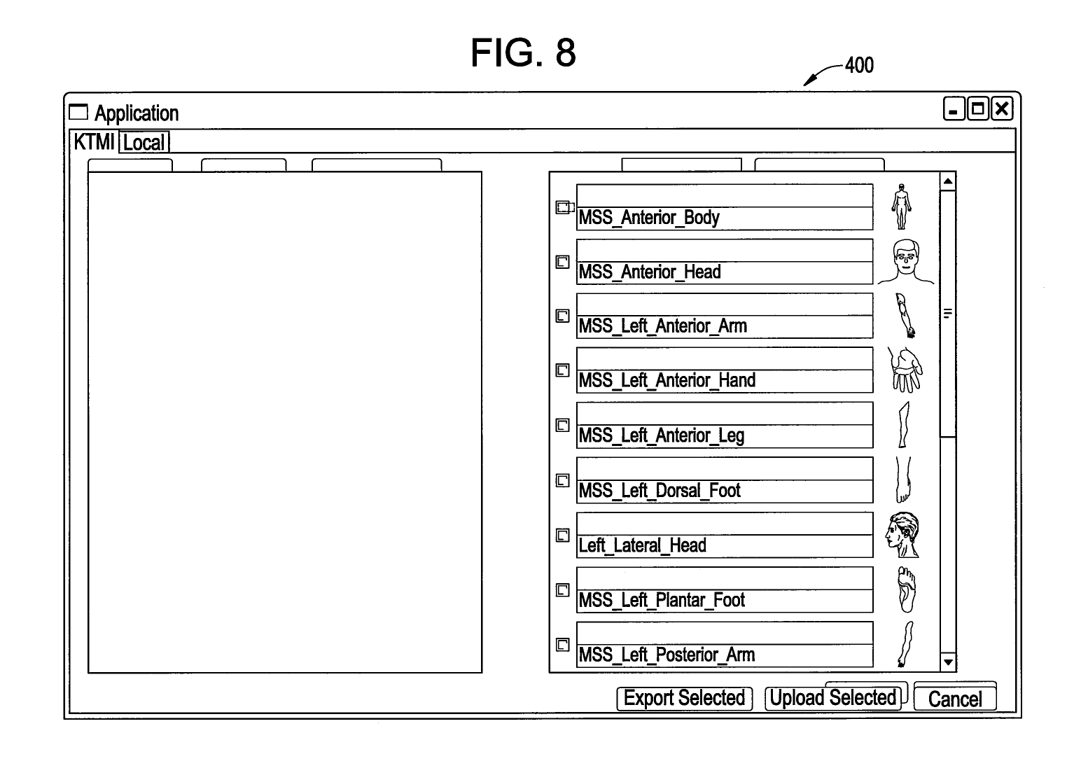

FIG. 8 shows a screen that allows the user to modify pre-set images already in the database. For example, the user could add an element to a pre-set image, delete and element from a pre-set image, change the orientation of a pre-set image, zoom in on one area of a pre-set image, zoom out to show a larger portion of a pre-set image, add new locations, update locations, increase image resolution, decrease image resolution, increase image size and/or decrease image size. The screen has various applications allowing a user to modify existing pre-set images in these manners. This allows the user to modify pre-set images without engineering involvement.

Certain embodiments of the present computer-readable medium having a set of instructions for execution by a computer include a user-manipulation routine configured to allow a user to manipulate at least one image; a first association routine configured to associate at least one location with each of the user-manipulated images; a second association routine configured to associate each of the user-manipulated image(s) and associated location(s) with at least one knowledge identifier; a storage routine configured to store the user-manipulated image(s), associated location(s) and associated knowledge identifier(s); and a selection routine configured to retrieve the user-manipulated image(s) and associated location(s) relating to a user-selected one of the knowledge identifiers.

In one example, a clinician using an enterprise clinical documentation system wants to modify an existing image of an entire human body by zooming in on the chest area. She could modify an existing pre-set image using the current system. She would open a window on her computer. That window would contain a user-operated location authoring tool such as (110) described above. She could use the user-operated location authoring tool to select the existing pre-set image of the entire human body. She could then use the various applications offered by the user-operated location authoring tool to zoom in on the chest area of the image. She could use the user-operated location authoring tool to add new, more specific locations to the newly created chest image. The system would then associate the newly added locations with the newly created image using a dictionary authoring service such as (120) described above. The system would also associate knowledge identifiers such as “chest” and/or “thoracic” with the newly created image using a runtime dictionary service such as (140) described above. The manipulated image of the chest, the newly added locations, the knowledge identifiers and the associations between the three would be dynamically stored in a database such as (130) described above. The clinician could then access her new drawing using a location selector such as (150) described above. She could indicate that she wanted a chest image and the location selector would retrieve all images with chest knowledge identifiers, including the newly created image. She could then select the newly created chest image. She could then chart her assessments using the newly added locations associated with the newly created chest image. Her new image and locations would remain in the database and could be accessed by other users at a later date.

In the example above, the clinician could also link her newly created chest image with the entire human body image from which she created it. This could be done using the user-operated location authoring tool such as (110) described above. She would indicate that she wanted to link the two images. The runtime authoring service such as (140) described above would then assign knowledge identifiers linking the two images. The two images, their associated locations, and the associated knowledge identifiers would be stored dynamically in a database such as (130) described above. When the clinician later selects one of the two images using the location selector such as (150) described above, the two images will both be retrieved because of their linked status.

In another example, a clinician using an enterprise clinical documentation system wants to create an entirely new image of a child for use in a new pediatric wing of the hospital. He could create an entirely new image using the current system. He would open a window on his computer. That window would contain a user-operated location authoring tool such as (110) described above. He could use the drawing applications of the user-operated location authoring tool to create the new image. The user-operated location authoring tool could offer common shapes that he could use in creating his new image. It could also offer common elements of images. For example, it could offer limbs, veins, arteries, nerves, and various types of tissue. He could use the user-operated location authoring tool to add new, more specific locations to the newly created child image. The system could also use a special application to assign other locations that he does not input. The system would then associate the new locations with the newly created image using a dictionary authoring service such as (120) described above. The system would also associate knowledge identifiers with the newly created image such as “child” and/or “pediatric” using a runtime dictionary service such as (140) described above. The newly created image, the newly added locations, the knowledge identifiers and the associations between the three would be dynamically stored in a database such as (130) described above. A second clinician could then access the new drawing using a location selector such as (150) described above. The second clinician could indicate that he wanted “child” image and the location selector would retrieve all images with the “child” knowledge identifier, including the newly created image. He could then select the newly created child image. He could then chart his assessments using the new locations associated with the newly created child image. The new image and locations would remain in the database and could be accessed by other users at a later date.

Thus, certain embodiments provide the technical effect of dynamically generating locations for charting assessments. Specifically, certain embodiments provide the effect of dynamically generating body locations for charting patient assessments.

Several embodiments are described above with reference to drawings. These drawings illustrate certain details of specific embodiments that implement the systems and methods and programs of the present invention. However, describing the invention with drawings should not be construed as imposing on the invention any limitations associated with features shown in the drawings. The present invention contemplates methods, systems and program products on any machine-readable media for accomplishing its operations. As noted above, the embodiments of the present invention may be implemented using an existing computer processor, or by a special purpose computer processor incorporated for this or another purpose or by a hardwired system.

As noted above, embodiments within the scope of the present invention include program products comprising machine-readable media for carrying or having machine-executable instructions or data structures stored thereon. Such machine-readable media can be any available media that can be accessed by a general purpose or special purpose computer or other machine with a processor. By way of example, such machine-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Embodiments of the invention are described in the general context of method steps which may be implemented in one embodiment by a program product including machine-executable instructions, such as program code, for example in the form of program modules executed by machines in networked environments. Generally, program modules include routines, programs, objects, components, data structures, etc., that perform particular tasks or implement particular abstract data types. Machine-executable instructions, associated data structures, and program modules represent examples of program code for executing steps of the methods disclosed herein. The particular sequence of such executable instructions or associated data structures represents examples of corresponding acts for implementing the functions described in such steps.

Embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated machine-readable media provide nonvolatile storage of machine-executable instructions, data structures, program modules and other data for the computer.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

Those skilled in the art will appreciate that the embodiments disclosed herein may be applied to the formation of any clinical software feedback and dynamic scheduling/planning system. Certain features of the embodiments of the claimed subject matter have been illustrated as described herein; however, many modifications, substitutions, changes and equivalents will now occur to those skilled in the art. Additionally, while several functional blocks and relations between them have been described in detail, it is contemplated by those of skill in the art that several of the operations may be performed without the use of the others, or additional functions or relationships between functions may be established and still be in accordance with the claimed subject matter. It is, therefore, to be understood that the appended claims are intended to cover all such modifications and changes as fall within the true spirit of the embodiments of the claimed subject matter.

1. A system for dynamically generating locations for charting assessments comprising:
a user-operated location authoring tool wherein said user-operated location authoring tool allows a user to manipulate at least one image;
an authoring dictionary service wherein said authoring dictionary service associates at least one location with each of said manipulated image(s);
a runtime dictionary service wherein said runtime dictionary service associates at least one knowledge identifier with said manipulated image(s) and associated location(s);
a database wherein said database stores said manipulated image(s), associated location(s) and associated knowledge identifier(s); and
a location selector wherein said location selector retrieves said manipulated image(s) and associated location(s) relating to a user-selected one of said knowledge identifier(s).

2. The system of claim 1 wherein said user-operated location authoring tool allows said user to manipulate said at least one image by modifying an existing pre-set image.

3. The system of claim 1 wherein said user-operated location authoring tool allows said user to manipulate said at least one image by creating a new image.

4. The system of claim 1 wherein said user-operated location authoring tool allows said user to manipulate said at least one image by linking said at least on image to at least one other image.

5. The system of claim 1 wherein said user-operated location authoring tool allows said user to manipulate said at least one image by modifying locations associated with said at least one image.

6. The system of claim 1 wherein said database updates dynamically.

7. The system of claim 1 wherein said system is a clinical system.

8. The system of claim 7 wherein said locations are body locations.

9. The system of claim 8 wherein said assessments are patient assessments.

10. A method of dynamically generating locations for charting assessments comprising:
creating at least one user-manipulated image;
associating at least one location with each of said user-manipulated image(s);
associating each of said user-manipulated image(s) and associated location(s) with at least one knowledge identifier;
storing said user-manipulated image(s), associated location(s) and associated knowledge identifier(s); and
retrieving said user-manipulated image(s) and associated location(s) relating to a user-selected one of said knowledge identifier(s).

11. The method of claim 10 wherein the steps are performed sequentially.

12. The method of claim 10 wherein said user-manipulated image is created by modifying an existing pre-set image.

13. The method of claim 10 wherein said user-manipulated image is created using a drawing tool.

14. The method of claim 10 wherein said user-manipulated image is created using common shapes.

15. The method of claim 10 wherein said user-manipulated image is created using commonly used elements of images.

16. The method of claim 10 wherein said method is a clinical method.

17. The method of claim 16 wherein said locations are body locations.

18. The method of claim 17 wherein said assessments are patient assessments.

19. A computer-readable medium having a set of instructions for execution by a computer, the set of instruction comprising:
a user-manipulation routine configured to allow a user to manipulate at least one image;
a first association routine configured to associate at least one location with each of said user-manipulated image(s);
a second association routine configured to associate each of said user-manipulated image(s) and associated location(s) with at least one knowledge identifier;
a storage routine configured to store said user-manipulated image(s), associated location(s) and associated knowledge identifier(s); and
a selection routine configured to retrieve said user-manipulated image(s) and associated location(s) relating to a user-selected one of said knowledge identifier(s).

20. The computer-readable medium of claim 19 wherein said computer-readable medium is for clinical use.
